(19) United States
(12) Patent Application Publication
(10) Pub. No.: US 2008/0103900 A1
(43) Pub. Date: May 1, 2008

(54) SHARING VALUE BACK TO DISTRIBUTED INFORMATION PROVIDERS IN AN ADVERTISING EXCHANGE

(75) Inventors: Gary W. Flake, Bellevue, WA (US); Brett D. Brewer, Sammamish, WA (US); Christopher A. Meek, Kirkland, WA (US); David Max Chickering, Bellevue, WA (US); Jody D. Biggs, Redmond, WA (US); Ewa Dominowska, Kirkland, WA (US); Brian Burdick, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/747,968

(22) Filed: May 14, 2007

Related U.S. Application Data
(60) Provisional application No. 60/862,969, filed on Oct. 25, 2006.

(51) Int. Cl. G06Q 30/00

(52) U.S. Cl. 705/14

(57) ABSTRACT

For a multi-party advertising exchange including advertising and publishing entities, automatic value sharing is provided for distributed users of the advertising exchange that provide valuable information to the exchange. Users provide information that has quantifiable value to the advertising exchange and/or its participants. In exchange for the information, predicated on any function or cost model for quantifying the value of the information, a reward or advantage, such as revenue, is given to the user by the advertising exchange and/or participants of the advertising exchange in order to incentivize users' valuable contributions. As a result, the advertising exchange becomes a more efficient marketplace, increasing predictability and the participant(s) benefit in correspondence with the value of any information received by those participant(s). Various refinements are provided and disclosed according to a host of optional embodiments.

### CROSS REFERENCE TO RELATED APPLICATIONS

This application claims priority to U.S. Patent Application Ser. No. 60/862,969, filed on Oct. 25, 2006, entitled “DISTRIBUTED ARCHITECTURES FOR ONLINE ADVERTISING”, the entirety of which is incorporated herein by reference.

### TECHNICAL FIELD

The subject disclosure relates to sharing value back to individual users who provide valuable information to online advertising architectures and environments.

### Background

Conventionally, large web search engines have sold advertising space based on keyword-driven search results. For example, Yahoo! conducts auctions for certain keywords, and the highest bidders have their ads placed on pages containing Yahoo! search results, or they obtain preferred placement among the search results, i.e., at the top of the results list.

As web advertising has developed, a number of companies are acquiring large publisher bases from which they can sell advertisements. For instance, Google is signing up publishers into their AdSense ad network to broker publishing space from the publishers to a set of participating advertisers bidding for and purchasing the advertising space. Advertisers pay Google to serve advertisements to participants of the AdSense network. Google then pays some or all of the advertising revenue to the individual publishers. For example, a publisher in the AdSense network may have an article on its website that talks about digital cameras, and Google's AdSense displays digital camera advertisements from advertisers in the AdSense network on that website. Google auctions off the “digital camera” keyword to advertisers in its AdSense network and displays ads from the highest bidders.

However, there are a number of problems with this proprietary ad network model. First, companies that are building ad networks have an inherent conflict of interest because, as a broker for advertising deals, they represent both the publisher and the advertiser. Second, because there are multiple companies that are creating ad networks, advertisers have the burden of managing buys across many ad networks, which results in significant cost and complexity to the advertiser. Third, because publishers are for all practical purposes locked into a single ad network due to legal restrictions when signing up, the advertiser competition is limited, which results in lower return for the publishers. Fourth, the lack of general standards around terms and conditions, and behavioral segmentation is a major obstacle to reaching the full market value of online display advertising. There is also no current standardization across publishers for accepted media types and ad formats. Fifth, smaller publishers currently have very little power individually, even if they serve a hard-to-reach audience. Additionally, ISPs and other owners of large user databases are not realizing the full value of the information they have due to privacy concerns and lack of a proper marketplace.

Moreover, by their proprietary and “closed” nature, other than users' acts of clicking (or not clicking as the case may be), which provides valuable click through rate data, such networks do not presently have any hooks by which users, external to advertising transactions conducted in the networks, can provide valuable information to the advertising network. Today, there is simply no broad mechanism to provide such value by users to an advertising network, even where they may like to do so without revenue sharing and where the participants of the exchange would enjoy the benefits of the information. Thus, it would be desirable to provide a system, application, service, etc. that enables such distributed users to provide valuable information to an online advertising network across a variety of scenarios to make for a more informed advertising ecosystem and better informed decisions by participants.

In addition, it would be desirable to reward such users as a way of incenting their actions that add value because today, there is no automatic way to share advertising revenue with such distributed users that wish to add value. To encourage the input of valuable information by such distributed users, it would thus be desirable to be able to automatically share revenue, or automatically provide some other reward, bonus, option, coupon, advantage, etc. back to such users that add value to the advertising network marketplace and participants.

The above-described deficiencies of current advertising environments are merely intended to provide an overview of some of the problems of today's advertising environments, and are not intended to be exhaustive. Other problems with the state of the art may become further apparent upon review of the description of various non-limiting embodiments of the invention that follows.

### SUMMARY

For a multi-party advertising exchange including advertising and publishing entities, the invention enables value sharing for distributed users of the advertising exchange. In various non-limiting embodiments, the invention enables a user to provide information, such as word association data, marketing data, demographic data, supply or demand trend data, etc., that has quantifiable value to the advertising exchange and/or its participants. In exchange for the information, predicated on any function or cost model for quantifying the value of the information, a reward or advantage, such as revenue, is then given to the user by the advertising exchange and/or participants of the advertising exchange in order to incentivize users' valuable contributions. As a result, the advertising exchange becomes a more efficient marketplace, increasing predictability and the participant(s) benefit in correspondence with the quantifiable value of any information received by those participant(s). Various refinements are provided according to a host of optional embodiments.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

Various embodiments of the value sharing for online advertising in accordance with the present invention are further described with reference to the accompanying drawings in which:

FIG. 1 is a block diagram of a computing system environment suitable for use in implementing the present invention;

FIG. 2 illustrates a distributed architecture for online advertising, according to embodiments of the present invention;

FIG. 3 illustrates one example of the flow of data within an exemplary non-limiting architecture according to embodiments of the present invention;

FIG. 4 illustrates a flowchart of the operation of an exchange, according to exemplary, non-limiting embodiments of the present invention;

FIG. 5 illustrates a flowchart of the operation of user or a user data broker to provide potentially valuable information according to embodiments of the present invention;

FIG. 6 is an exemplary non-limiting block diagram of an embodiment of an online advertising exchange in accordance with the invention;

FIG. 7 is an exemplary non-limiting block diagrams of embodiments of the automatic value sharing for an online advertising exchange in accordance with the invention;

FIG. 8 is an exemplary block diagram illustrating an alternate embodiment of the automatic value sharing for an online advertising exchange in accordance with the invention;

FIG. 9 illustrates yet another exemplary block diagram illustrating an alternate embodiment of the automatic value sharing for an online advertising exchange in accordance with the invention;

FIG. 10 illustrates exemplary performance tracking of information provided by users in accordance with the invention;

FIG. 11 illustrates an exemplary spectrum of user information quality in an exemplary non-limiting embodiment of the invention;

FIG. 12 illustrates exemplary non-linear weighting of user information quality in an exemplary non-limiting embodiment of the invention;

FIG. 13 illustrates another exemplary block diagram illustrating an alternative embodiment of the automatic value sharing for an online advertising exchange in accordance with the invention;

FIG. 14 illustrates still another exemplary block diagram illustrating the automatic value sharing for an online advertising exchange in accordance with the invention;

FIG. 15 illustrates an exemplary application for receiving value added information from distributed users in accordance with automatic revenue sharing in accordance with the invention;

FIG. 16 illustrates an exemplary non-limiting block diagram of the revenue sharing model for facilitators in accordance with the invention; and

FIG. 17 is a flow diagram illustrating an exemplary method or process for inputting user information of potential value for sharing back to the associated user in accordance with the invention.

### DETAILED DESCRIPTION

### Overview

In various embodiments, the invention is described in the context of a distributed architecture for online advertising, i.e., a market mechanism that manages the exchange of advertising goods among multiple participants on the advertising and/or publishing side, and across disparate advertising networks that today are exclusive of one another as described in the background. In consideration of the limitations on existing architectures, the invention enables any participant in a multi-party advertising exchange to quantify value for information generated by distributed users, and to share a benefit, such as a percentage of revenue, or expected revenue, obtained because of the information, back to those distributed users that generate positive value for the participant. The value sharing can be performed automatically as part of conducting transactions in the exchange.

Accordingly, tools, services, applications, systems, etc. are provided by which users can generate valuable information, the value of which may be quantified by an advertising exchange according to a function defined by the participant and/or exchange, and then shared back to the user as a function of the quantifiable value. Thus, distributed users who wish to gain or profit by providing information to the advertising exchange are provided with one or more “hooks” into the advertising exchange according to a broad set of scenarios whereby the users can provide information of quantifiable value to the advertising exchange, and by which such users can be compensated in relation to such value.

To encourage the input of valuable information by such distributed users, the invention thus enables automatic sharing of revenue, or some other reward, bonus, option, coupon, advantage, etc. back to such users that add value to the advertising network marketplace and participants. The invention thus makes the advertising marketplace more efficient by incorporating extra information in the exchange, thereby reducing variance in results from advertising transactions, and/or providing participants with a competitive advantage.

In other embodiments, the invention enables an advertising exchange to track the performance of information provided by each user, maintaining one or metrics, such as a quality metric, for the user so that over time, a function may be applied such that users with high metrics receive more sharing back than users with low metrics. This way, once a user becomes known to be a low value user, the influence of that user on the advertising exchange marketplace and the behavior on participants is minimized since such user will receive little to no compensation for the user's efforts. This additionally incentivizes users to be high value users, the cost of which is borne by any entity that benefits or derives value from the quantifiable information.

Advertising systems of the invention facilitate trading of advertising and may be a federated advertising exchange that provides a federated advertising layer for disparate advertising networks. The advertising system may include (A) a publisher broker to represent publishers that determines an ask for an advertisement space on the publishers' inventory, such as a webpage, (B) an advertiser broker to represent advertisers that manages the advertisers' bids for the advertisement space to display the advertisers' advertisements and (C) an exchange to facilitate a transaction for the advertisement space between the publisher broker and the advertiser broker. As mentioned, the invention provides for distributed user input of information to the advertising system, from which an entity associated with the exchange derives value.

A simplified overview has been provided in the present section to help enable a basic or general understanding of various aspects of exemplary, non-limiting embodiments that follow in the more detailed description and the accompanying drawings. This overview section is not intended, however, to be considered extensive or exhaustive. Instead, the overview presents some concepts related to some exemplary non-limiting embodiments of the invention in a simplified form as a prelude to the more detailed description of these and various other embodiments of the invention that follows.

### Exemplary Operating Environment(s)

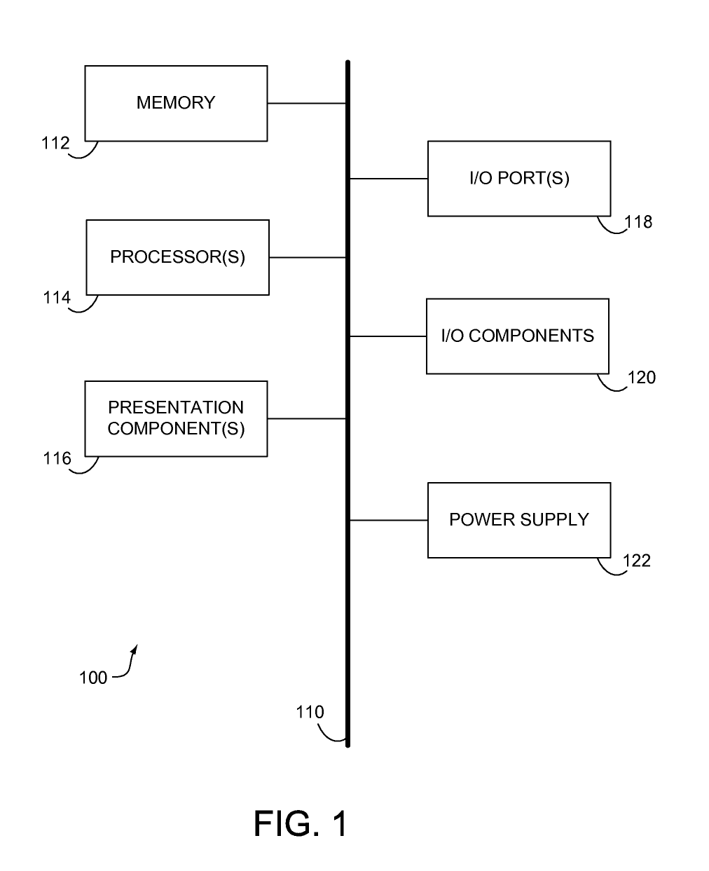

Referring initially to FIG. 1, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components illustrated. In accordance with the invention, users or participants can communicate with an advertising exchange via one or more computing devices 100, and the advertising exchange may also comprise one or more computing devices 100, in order to carry out one or more aspects of the invention described in detail below.

In this regard, the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following elements: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory, or otherwise communicate with memory. It should be noted that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

### Exemplary Architecture(s) for Online Advertising

Exemplary online advertising environments or architectures in which one or more of the various embodiments of the value sharing for user information in an online advertising exchange of the present invention may be deployed or implemented are now described. For the avoidance of doubt, such exemplary implementations and details for advertising transactions and advertising architectures and environments are not to be considered as limiting on the broad scenarios enabled by the invention for automatically sharing back benefits to users in exchange for valuable information in accordance with the invention.

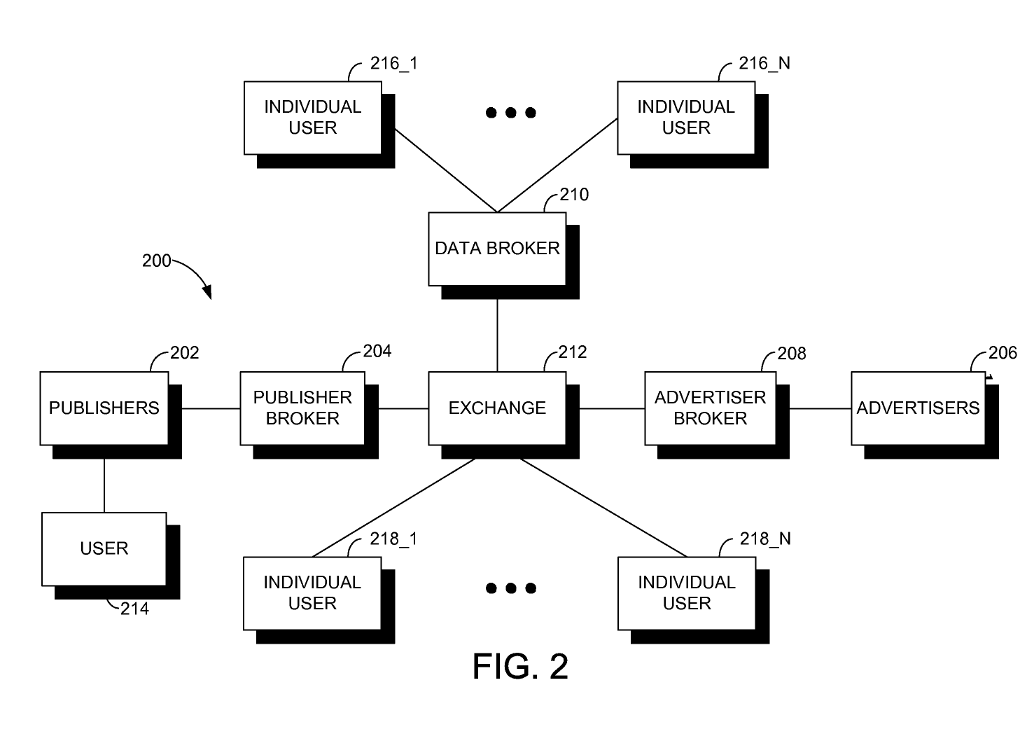

For instance, FIG. 2 illustrates an exemplary distributed architecture 200 for online advertising, which comprises publishers 202. For purposes of explanation only, publishers 202 will be discussed herein as a group of any number of publishers. However, embodiments of the present invention are not limited to a group of publishers, as a single publisher is sufficient. Also, embodiments of the present invention are not limited to a single group of publishers, as any number of groups of publishers may be present in architecture 200.

In an embodiment, each publisher is a content provider. For example, a construction worker who operates a single page website on which he posts a weblog (blog) may be a publisher. In another example, a media company such as Disney, which operates a huge website with many pages of content, may also be a publisher. Publishers 202 are intended to represent any number of types, sizes, sophistication levels, etc. of publishers. In an embodiment, publishers 202 desire to sell advertisement space on their websites to advertisers 206 (discussed below).

Architecture 200 also comprises publisher broker 204. For purposes of explanation only, only one publisher broker will be discussed herein. However, embodiments of the present invention are not limited to a single publisher broker, as any number of publisher brokers may exist. In an embodiment, publisher broker 204 is an aggregator of publishers. Specifically, publisher broker 204 is an entity that represents publishers 202 with the goal of maximizing ad revenue, ensuring quality ads, or any other goals specified by publishers 202. Publisher broker 204 breaks the conflict of interest that is inherent in systems such as Google's AdSense by solely focusing on managing publishers 202's yield according to publisher defined goals. Publisher broker 204 allows small and mid-size publishers (such as those that may be represented by publishers 202) to aggregate in order to drive higher yield for themselves. In an embodiment, publisher broker 204 maintains a user interface through which it interacts with publishers 202 and through which it manages publishers 202's preferences.

In an embodiment, publisher broker 204 comprises a publisher center and a publisher delivery system. The publisher center allows publishers to manage their preferences. The publisher delivery system is used to calculate the ask for a given page view on the publisher's site, and potentially enrich the available user data in the request. In an embodiment, the ask is an asking price. However, embodiments are not so limited, as the ask may be, e.g., a minimum cost-per-click, minimum relevance, some other performance metric, etc.

The publisher center establishes traffic inventory groupings in the system and sets asks. When a user makes a page request to the publisher, the publisher populates their page with some scripting that sets up a call to the publisher broker. The publisher may add in some information about the user to the call to the publisher broker (the incentive would be that more publishers would want to use a publisher broker that had this sort of value added service). The publisher broker determines what the ask should be for a particular request, given the user information present, the inventory grouping that the request falls into, and the rules the publisher has set up around that information. Additionally, the publisher broker will pass along the maximum amount that the publisher is willing to pay to have any unknown data attributes about the user populated for this request. The publisher broker may encode this information into a request URL that it sends back to the user as a redirection URL. When all transactions have occurred in the exchange (see below), a call back is provided to the publisher broker stating whether and how many ads were displayed, what the publisher broker can expect in terms of a payment, and which incremental attributes about the user were filled, for instance, by a data broker (see below).

Architecture 200 also comprises advertisers 206. For purposes of explanation only, advertisers 206 will be discussed herein as a group of any number of advertisers. However, embodiments of the present invention are not limited to a group of advertisers, as a single advertiser is sufficient. Also, embodiments of the present invention are not limited to a single group of advertisers, as any number of groups of advertisers may be present in architecture 200.

In an embodiment, each advertiser purchases ad space on websites, though any digital representation of advertising can be included in embodiments of the invention. For instance, in addition to any digital representation of advertising, an advertising exchange may reflect the display properties of billboards, printed media and publications, TV, Radio, etc., or any traditional means for publishing advertising, as long as the advertising is purchased and sold within the exchange. In this respect, any of the foregoing media can be characterized by information that may be valuable to one or more entities to a transaction involving such media.

For example, a local businessperson who operates a website for her small flower shop and who advertises on a neighborhood homeowners' association website may be an advertiser. In another example, a massive corporate entity such as General Motors, which has thousands of products and services, and which advertises on thousands of automotive-related websites may also be an advertiser. Advertisers 206 is intended to represent any number of types, sizes, sophistication levels, etc. of advertisers. In an embodiment, advertisers 206 desire to pay money to place ads on publishers 202's websites.

Architecture 200 also comprises advertiser broker 208. For purposes of explanation only, only one advertiser broker will be discussed herein. However, embodiments of the present invention are not limited to a single advertiser broker, as any number of advertiser brokers may exist. In an exemplary non-limiting embodiment, advertiser broker 208 is an aggregator of advertisers. Specifically, advertiser broker 208 is an entity that represents advertisers 206 with the goal of optimizing advertisers 206's spending and placing monetary values on displaying advertising of a particular format, on a particular website, to a particular audience. In an exemplary non-limiting embodiment, advertiser broker 208 maintains a user interface through which it interacts with advertisers 206, and through which it manages advertisers 206's preferences, such as preferences for particular user data attributes. However, embodiments of the present invention are not limited to any particular advertiser preferences.

In an embodiment, an advertiser sets up ads in the advertiser broker system, but has no further interaction with the exchange (see below) or end user until such a point as the end user clicks on their ad. This means that the advertiser does not see any valuable information that has been populated by data brokers (see below) as part of the exchange transaction. In an embodiment, the exchange (see below) carries enough information to allow for advertisers to setup self-optimizing campaigns based only on landing URLs, creatives, and campaign goals, though the invention is not limited by such examples. Similarly, algorithms can be run on advertiser landing URLs to choose possible valuable information, such as subsets of audience attributes, as well as relevant topics (keywords, categories, and content pages). The available features can then be selected to maximize the campaign goals, for example branding campaigns would minimize the amount paid per impression and maximize the coverage and inventory quality. A sales campaign on the other hand would be selected to track performance, such as conversions, and maximize (or minimize as the case may be) performance, such as optimizing the number of high value conversions, for the existing advertiser budget.

Where individual information providers in accordance with the invention communicate their information through an intermediate component, architecture 200 may also comprise data broker 210. For purposes of explanation only, only one data broker will be discussed herein. However, embodiments of the present invention are not limited to a single data broker, as any number of data brokers may exist. In a non-limiting embodiment, data broker 210 is an aggregator of user data providers 216_1 to 216_N, i.e., the individual providers of potentially valuable information in accordance with the invention. A user data provider is any entity that maintains any full or partial information potentially valuable information that can be referred back to individual users (such as one of users 216_1 to 216_N) who provided the information.

In other non-limiting embodiments, architecture 200 includes tools, applications, services, components, etc. that enable a set of distributed users 218_1 to 218_N to provide information directly to the exchange without a data broker 210 as a middle layer. In such embodiment, in some respects, the exchange 212 itself operates as a data broker as the go between individual users and the potentially valuable information they provide to the advertising ecosystem, and the transactions conducted in the exchange 212 that are enriched by the information provided.

Publishers may be interested in the information provided by a data broker 210 or users 218_1 to 218_N, independently of the advertisers on the advertising exchange. For example, a publisher may want to show different content on their web site to users based on the gender of the users, e.g., to attract more people to the site. In this regard, the publisher may be interested in buying information for presentation purposes, independently of the advertisers in the exchange. Thus, both advertisers and publishers participating in an advertising exchange are interested in potentially valuable information wherever the information enriches their experience within the exchange.

It is noted that potentially valuable information in accordance with the present invention contemplates any kind of valuable information that enriches the marketplace of the exchange for any one, subset or all of the participants in an exchange. For some non-limiting examples, user data may comprise demographic, psychographic, or behavioral information, performance information such as conversion rates and clickthrough rates, correlation information for a set of keywords, and so on. Often times, participants to an advertising transaction will want to know about a target audience, in which case information about the target users is valued as part of the transaction, and may be compensated in accordance with the invention commensurate with the value added by any such information. More specifically, for example, user data may comprise age, gender, wealth index, interests, shopping habits, etc. Any individual user can function according to the present invention to provide user location and user pattern information, such as purchase pattern information, for other users. For instance, this information can be aggregated with demographic profiles from other individual users to form more comprehensive user descriptions that are of value within the exchange. However, embodiments of the present invention are not limited to any specific type of user data, or to user data at all, since as mentioned, any valuable information is contemplated in accordance with the invention.

In an embodiment, users 218_1 to 218_N or data broker 210 enriches information regarding a user viewing one of publishers 202's web pages. In an exemplary non-limiting embodiment, data broker 210 does not disclose any personally identifiable information about its users. In a non-limiting embodiment, data broker 210 accomplishes this by performing a private user ID lookup and passing back a set of aggregate information from users that could be consumed by advertisers 206 and advertiser broker 208. This informational enrichment can increase the value of the display of the ad to advertisers 206, can help produce more relevant ads to consumers, and can create a more complete picture of the potentially valuable information for ad serving purposes without violating the user's privacy. The aggregation across different information providers serves two independent roles, in an embodiment: (1) it creates a comprehensive view of the informational landscape, and (2) it thickens the data sources to allow for anonymization and preservation of user privacy.

In an embodiment, on behalf of the users for which it aggregates potentially valuable information, data broker 210 receives direct payment for even small and/or partial user information aggregated. Users 218_1 to 218_N may in turn be paid directly without the role of external data broker 210. By participating in architecture 200, users 218_1 to 218_N or data broker 210: (1) may be paid commensurate for the value add represented by its information, (2) can enrich its information by aggregating information from a set of distributed individual users (even redundant data providers are useful for scoring purposes), and (3) can verify its information (providers with poor quality of data will be ferreted out through comparing efficacy of the information provided, actively addressing data quality issues). In an embodiment, data broker 210 receives a request from publisher broker 204 proxied by exchange 212 (explained in greater detail below). Data broker 210 appends or otherwise incorporates known valuable information into this request for the consumption of advertiser broker 208. In one embodiment, data broker 210 does not know more than individual users optionally contribute. For instance, individual providers of information can instruct data broker 210 not to pass any user identifiers to entities within the exchange.

In an embodiment, data broker 210 comprises a user data recorder to record user information into the exchange (discussed below) and a user data delivery system to respond to requests for the user information. In an exemplary non-limiting embodiment, the user data recorder informs the exchange that the data broker knows something about a user, through whatever means that may be. For some non-limiting examples for how to achieve such communication, when the data broker has contact with a user that they know something about, the data broker can either set up a single pixel gif call to the exchange that the user will perform, or the data broker can redirect the current user request to the exchange, along with the information and a destination URL for the exchange to redirect the user to afterwards. In each case, whatever information or data key the data broker wishes to receive back is expected to be enough so that the data broker can answer user data delivery system requests for the use. In an exemplary non-limiting embodiment, the information passed to the exchange is signed in a manner that proves the identity of the data broker to the exchange.

In an cookie-based embodiment, the exchange, upon verifying the identity of the data broker, sets a cookie to the user's browser with the name of the cookie identifying the data broker, and the cookie value being the information provided. In an exemplary non-limiting embodiment, when the exchange receives an ad request from a user (the user having been sent to the exchange from a publisher broker), if there are any user data attributes that the publisher is willing to pay an additional amount for, then the cookies for all data brokers are read from the user's browser. For each data broker identified by a cookie, if the data broker is currently live, the exchange will send a request to that audience broker with the cookie value and any unknown data attributes which the publisher is willing to pay to have provided. The data broker then responds back, including the information for as many attributes as they know, along with the price they are asking for to allow it to be used.

In an embodiment, data brokers can participate in an advertiser auction and get paid directly through an advertiser bid with no data requests from the participants in the exchange. This would be considered a “participant blind” data delivery. If an advertisement bid meets and exceeds a publisher requested minimum, then the bid remainder left after publisher ask can be used to acquire user data and maximize advertiser ROI (return on investment) using tighter targeting. The exchange provides a call back to the winning data broker(s) letting them know what information they provided was deemed valuable, and what amount they will be paid for that information. To avoid micro transactional complexity due to the typically small amount of money that a single user's information is likely to be worth, this amount can be collected in an account on behalf of the user, and when a threshold amount of money is collected on the user's behalf, the money is disbursed to the user. For instance, when $20 is collected in a particular user account, the money is disbursed.

For the avoidance of doubt, exemplary embodiments herein describe a data broker in the context of advertisers benefiting from the information output by the data broker, however, as noted earlier, publishers also benefit from the potentially valuable information provided by users. For instance, in addition to other utility functions or biases expressed by a publisher to an online advertising exchange in accordance with the invention, the publisher's utility function might be expressed as a function of a specific user. For example, a publisher might want all the advertisements to be “age appropriate” for the users of the publisher's site. Information about which advertisements are “age appropriate” is thus of potential value to that site.

Given that publishers and advertisers can apply payments directly to data brokers for specific information, in an exemplary non-limiting embodiment, there is a verification and rating process for data brokers and the users on behalf of which information submittal to the exchange is tracked and aggregated. Multiple data brokers may be competing for the same service. In an exemplary non-limiting embodiment, competition is performed based on ask, but also based on quality of information made available. Advertisers will have transparency into the publisher broker network, and similar transparency can be offered into the individual information providers by offering a rating system. Data broker and individual user ratings can be calculated dynamically through the use of overlapping collection symbols. Data broker ratings can be made a function of the individual user ratings giving data brokers an incentive to aggregate on behalf of a highly knowledgeable set of individual users.

Overlapping data can be used to calculate ground truth predictions as well as verify the data provided by individual users or data brokers. This information in turn could be used to automatically rate data brokers and/or users. In an exemplary, non-limiting embodiment, a simple voting system can be used to verify the accuracy of any specific collection symbols for each broker, or the quality of the broker as a whole. The maintainers of the exchange would be responsible for publishing the voting consensus to the public, or to disbar the broker or user, as the case may be, completely if necessary.

In an embodiment, no data broker will be able to provide ground truth data for all users. However, it might be possible to generate such data by creating data functions based on different providers and choosing the consensus opinion for each type of information provided by users. Publishers and advertisers could choose to use the consensus opinion or any individual data broker's collection symbols. In an embodiment, data units of “statistically significant” types of information provided by a user could be created. Most data brokers often run into privacy issues, not due to the data they have, but due to the data they don't know. Holes in a user profile could be significant or unique enough to be carrying sufficient information to reconstruct a unique user. Filling-in these holes using data from other user data providers could allow those providers to generate statistically significant aggregates that can be used for research purposes without sacrificing user privacy.

In one embodiment of the invention, data broker 210 can aggregate information from individuals about user attributes, or advertising or publishing trends with respect to the efficacy of certain transactions in the exchange. Armed with this information concerning the efficacy of certain transactional characteristics, the exchange and the participants in such transactions can potentially benefit from that information. In accordance with various non-limiting embodiments of the invention, that benefit is quantified and the user that provides the information is compensated commensurate with that benefit.

Architecture 200 also comprises exchange 212. Exchange 212 acts as a mediator among publisher broker 204, advertiser broker 208, and information providers, such as users 218_1 to 218_N and/or data broker 210. Exchange 212 is the framework that thus allows publisher broker 204 to have its ads enriched with additional information, such as additional user data, by data broker 210. In an embodiment, exchange 212 routes traffic and facilitates transactions, e.g., auctions, between publisher broker 204, advertiser broker 208, and data broker 210. In an exemplary non-limiting embodiment, exchange 212 is a server or a set of servers. Exchange 212 creates a system in which data broker 210 can monetize its data and in which advertiser broker 208 or publisher broker 204 can achieve satisfying goals, such as reach a larger audience of more highly targetable traffic.

To provide minimum standards of conformity, in an embodiment, exchange 212 provides collection symbols related to the category of the publisher's page, the meaningful keywords in it, as well as geo-location information extracted from the user's IP address. The base data, such as the user IP address, the URL of the publisher's page, and any other such information deemed relevant should also be provided to each advertiser broker so that the advertiser broker may attempt to extract additional information to provide value-added services to the advertisers they service. In an exemplary non-limiting embodiment, exchange 212 sends all publisher broker requests that match a set of criteria defined by the advertiser broker, along with all relevant data about the request (e.g., the ask and collection symbols provided by the publisher, data broker, and the exchange itself). In an embodiment, if the advertiser broker has any ads that it would like to have displayed and that meet the ask, it returns those ads, up to the number of ads requested, along with a CPI (cost per impression) bid on each. However, embodiments are not limited to CPI pricing, as other pricing models may be used, e.g., CPC (cost per click), CPA (cost per acquisition), CPM (cost per thousand impressions), i.e., any cost model may be used in connection with revenue sharing in accordance with the invention. Exchange 212 provides a call back to the winning advertiser broker(s) telling it which ads were displayed, and at what prices.

As mentioned above and emphasized again here, the exchange 212 is by no means constrained by such examples. Rather, the information provided by a user can be any kind of information from which a participant, such as publisher broker 204 or advertiser broker 208, may derive benefit, or as a result of which the marketplace represented by the exchange becomes more certain in terms of expected outcomes in transactions for participants.

Architecture 200 also comprises users 218_1 to 218_N. For purposes of explanation only, in some embodiments herein, only one user is discussed herein. However, embodiments of the present invention are not limited to a single user, as any number of users may exist, and the strength of the user in accordance with the present invention is realized even more when there are many users contributing aggregate views over different types of valuable information for transaction in an advertising exchange. Users 214 are typically thought of as requesting a webpage from publishers 202, or otherwise being those that experience advertising, whereas users 218_1 to 218_N as discussed herein may include anyone who individually contributes potentially valuable information to an exchange, either directly, or through a data broker, as described above, and who is automatically rewarded for that contribution as a function of the value provided by the information. For instance, though other types of advertisement space are contemplated in accordance with the invention, a webpage typically comprises content and advertisement space, which is filled with advertisement(s) from advertisers 206.

In operation, using architecture 200, information can be provided to participants in the exchange either by enriching the publishing property with competitive intelligence about customers, or by acquiring the data directly from users 218_1 to 218_N or data broker 210 on the basis of a licensing fee. Advertiser broker 208 can choose to pay an estimated monthly per volume amount for each category of information that their advertisers are interested in targeting. This transaction may also be performed off-line but can be automatically registered with exchange 212 to facilitate data rerouting at request time. Advertiser broker 208 can base its bids on any information, such as targeting attributes, provided by individual users 218_1 to 218_N or data broker 210. For example, advertisers 206 may place base bids either on a CPC or CPM basis and have the option to incrementally bid for any extra information, such as a particular set of interesting user attribute values, exposed to them. As mentioned, advertiser broker 208 is free to pay higher rates for redundancy or higher data quality. Advertiser broker 208 may manage the risk surrounding assessing individual advertiser performance and converting all bid types to CPI for final ranking by exchange 212. In an embodiment, the pricing model is similar to the pricing models discussed above.

To support the flexibility of all of CPC, CPM, CPA, etc. pricing models, and even to allow for others in the future, in an exemplary non-limiting embodiment, exchange 212 is based on a CPI model between publisher broker 204 and advertiser broker 208. In this regard, on each request, publisher broker 204 sets a minimum ask, i.e., reserve price, for their available ad space. Advertiser broker 208 in turn places a bid on the right to have their ads displayed on this request.

As discussed above, embodiments are not limited to CPI pricing only. In this regard, exchange 212 may take a small portion of the revenue flowing through it to support its operations, which can either be implemented via incrementing the publisher ask by some percentage, or by making agreements with publishers 202 that some percentage of the revenue generated from their traffic will be held back. That small portion may include a support fee for supporting the ability to receive valuable information from distributed users in accordance with the invention.

Because publishers 202 are concerned with user satisfaction, they would prefer to have some control over the relevancy of the ads placed on their site. Click-through rate is considered a good measure of relevance and therefore many publishers might want minimum click-through guarantees on the ads. Exchange 212 allows publishers 202 to optionally specify a minimum click-through rate that is acceptable. Exchange 212 monitors advertiser broker 208 to make sure that if it wins these types of asks, then it is meeting the performance guarantees. In an embodiment, if an advertiser broker consistently provides low click-through rates for publisher asks that require a minimum, exchange 212 may take punitive measures such as suspension from the system. Thus, these are further non-limiting examples of valuable information that may be provided to the exchange directly or indirectly in accordance with the invention, for which revenue may be shared to the provider of the information.

Another non-limiting example includes aggregated information from a plurality of users pertaining to the clickthrough rate of a particular advertising property. In such an embodiment, a user may opt to continuously record and provide to the exchange information about the user's clickthrough rates for advertising. In aggregate across a lot of users, this is useful information, for which compensation can be owed to the individual users. While the actual amount paid to a user for useful information may be low (e.g., a penny or a nickel), over time, an individual can accumulate a more significant amount for his or her value added information provided to the exchange.

Advertiser broker 208 may be responsible for converting any externally facing pricing models it allows into the CPI bid on each request. In this regard, the more information available in each request, the better job advertiser broker 208 can potentially do in predicting performance (e.g., probability of a click or a conversion). Since it is expected that advertiser broker 208 will therefore desire additional information along with each request to help it predict what those probabilities are, as well as to allow the advertiser to express a preference for one or another of the categories of information provided by users to the exchange by bidding differently, they will want to have information from users or data broker 210 at request time.

The pricing model between data broker 210 and advertiser broker 208 will be a market where data broker 210 sets minimum guarantee asks, as well as CPM pricing rates. In an embodiment, advertiser broker 208, if it wishes to use information from users 218_1 to 218_N, will agree to pay the greater of the guarantee amount or the CPM rate for the number of ad impression auctions that it wins. Exchange 212 tracks the number of ad impression auctions advertiser broker 208 wins, as well as to query for an attach data broker 210's user information to the request sent to advertiser broker 208.

The entity hosting exchange 212 has access to all data sources, giving it the power to make partial decisions. To alleviate the concern that exchange 212 might not be impartial both as hosting body and as a direct participant, in an exemplary non-limiting embodiment, transparency is built into exchange 212. In this embodiment, exchange 212 does not have a way to identify brokers of any kind, only valuable information as coming from a common source, whatever the source may be. Also, in such embodiment, advertiser auction algorithms and advertiser to publisher and data broker matching algorithms are standardized and transparent to all exchange participants. In this non-limiting embodiment, no user identifiable information is sent to advertisers 206 until the user performs an action. Exchange 212 passes advertiser broker 208 only the valuable information. Advertisers 206 do not see the user identifier. At click-time, however, it is still possible for an advertiser to establish a user identifier and associate the bidding profile with that user. By participating in architecture 200, data broker 210 is explicitly sharing its information with advertiser broker 208. In various non-limiting embodiments, the auction system is centralized at the exchange level by requiring that advertiser broker 208 specifies a value function that is evaluated for each ask on exchange 212. For example, exchange 212 could require a linear value function, and advertisers 206 would specify a base bid and a bid increment for each piece of potentially valuable information of interest to the participant. Exchange 212 would control the instantiation of the potentially valuable user data, thus not leaking any to advertiser broker 208.

In one example, Expedia as an advertiser has an ad for “cheap vacations in Bali.” Expedia chooses the keyword “Bali vacations.” Business intelligence suggests that the best way to target vacation ads is around users who have a history of purchasing vacations, users who live in overcast locations, users who recently have purchased books on vacations and users who perform searches related to travel. Expedia decides to license user information from a plurality of users (Robert, Jim, Zara, Mohammed, Gustov, Alice, etc.), who generally fit that profile, which enables an aggregate and more complete picture of their target audience. As mentioned, a data broker may also broker the user information from the plurality of users. Expedia agrees to pay Robert 1 cent for using their user information for each ad impression. Similarly, Expedia agrees to pay 1 cent to Mohammed, but due to the quality of Zara's information, Expedia agrees to pay 3 cents to Orbitz. The money, or other equivalent benefit, accumulates in an account on behalf of each user.

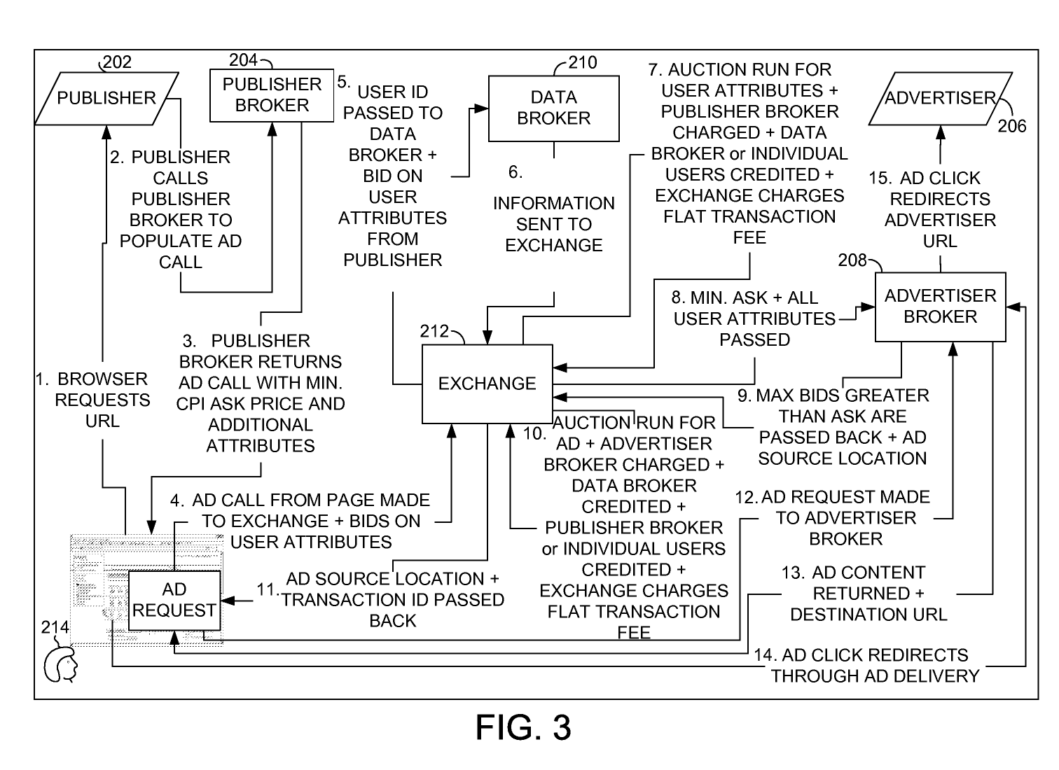

FIG. 3 illustrates one non-limiting example for the flow of data within architecture 200 according to embodiments of the present invention. Referring to FIG. 3, a user 214 opens a browser and requests a URL of a webpage from publisher 202 (1). In an exemplary non-limiting embodiment, the webpage has some advertisement space available, which publisher 202 desires to sell to an advertiser. Publisher 202 calls publisher broker 204 to populate the ad call (2). Publisher broker 204 returns the ad call with a minimum CPI ask price and additional attributes (3). The ad call is made to exchange 212 along with bids on user attributes and a user identifier (4).

In accordance with the invention, exchange 212 passes the user identifier and the bid on attributes to individual user(s) 218_1 to 218_N or data broker 210 (5). In an exemplary non-limiting embodiment, information identifiers are stored on the user-side and are sent with the ad call to exchange 212 so that exchange 212 can identify which individual user(s) 218_1 to 218_N or user data broker(s) 210 may have potentially valuable information to help enrich the exchange 212. Data broker 210 and/or the individual user(s) 218_1 to 218_N look up the user identifier and respond with potentially valuable information along with an optional ask price for the information (6). In an exemplary non-limiting embodiment, exchange 212 runs an auction having some relation to the potentially valuable information, charges publisher broker 204, credits data broker 210 or individual user(s) 218_1 to 218_N for the value of the information provided, and holds back a flat transaction fee (7). For instance, exchange 212 passes a minimum ask plus any knowledge or information gained about all user attributes to advertiser broker 208 (8). Advertiser broker 208 responds with all of the bids that are greater than the ask, along with the ad source location (9). In an exemplary non-limiting embodiment, exchange 212 runs an auction for the ad, charges advertiser broker 208, credits data broker 210 or individual user(s) 218_1 to 218_N and publisher broker 204, and holds back a flat transaction fee (10). Exchange 212 passes the ad source location and transaction identifier back (11). An ad request is made to advertiser broker 208 (12), which responds with the ad content and a destination URL (13). If user 214 clicks on the ad, the user is redirected by advertiser broker 208 (14) to advertiser 206 (15). The above example illustrates just one embodiment of the present invention. Other embodiments may not involve the same operations or conduct them in the same order. Specifically, other examples may not rely on auctions to set prices, instead relying on a firm ask that can be accepted or declined. Moreover, other kinds of advertising and publishing inventory than webpages can also benefit from the revenue sharing in accordance with the invention.

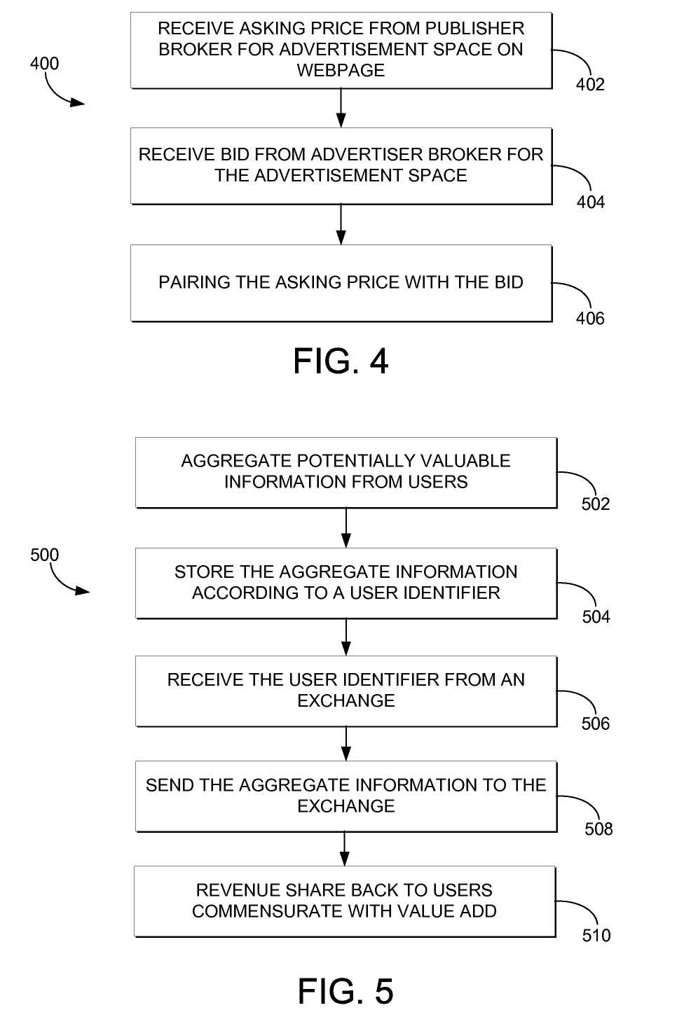

FIG. 4 illustrates a flowchart of the operation of an exchange, according to embodiments of the present invention. Referring to FIG. 4, method 400 begins with the receipt of an ask from a publisher broker for advertisement space on a webpage (402). A bid is received from an advertiser broker for the advertisement space (404). In an exemplary embodiment, bids are received from many different advertiser brokers. The ask is paired with one of the bids (406) and the advertisement space on the webpage is awarded to the winning bidder. As discussed in greater detail above, other information such as user attributes may be attached to the ask by users or brokers for the users in accordance with the invention, and quality of the bidding advertisers may be examined prior to the advertisement space being awarded.

FIG. 5 illustrates a flowchart of the operation of a data broker according to embodiments of the present invention. Referring to FIG. 5, method 500 begins with the aggregation of user information (502), i.e., information received from individual information providers that adds value to transactions in the exchange. The aggregate user information is stored according to user identifiers (504). When the user identifiers are received from an exchange (506), the aggregate user information corresponding to that user identifier is sent to the exchange (508). In an embodiment including a data broker for a set of individual information providers in accordance with the invention, the data broker may set a cookie on the user computer to identify itself as having potentially competitive or valuable information. When the exchange reads that cookie, it knows which users or data brokers to query for the potentially valuable information. At 510, after the value of the information is quantified, a benefit is automatically conferred on the user providing the information based on the quantified value of the information.

Accordingly, in non-limiting embodiments, the invention includes a system to facilitate trading of advertising by having a publisher broker to represent publisher(s) that determines an ask for an advertisement space on the publisher(s)' webpages. An advertiser broker also represents advertiser(s) and manages an advertiser(s)' bid for the advertisement space. The exchange of the invention then facilitates transactions for advertisement space between the publisher broker and the advertiser broker, and enables the sharing back of value provided to the system by individual users that are incented by personal gain, e.g., profit motives from revenue sharing.

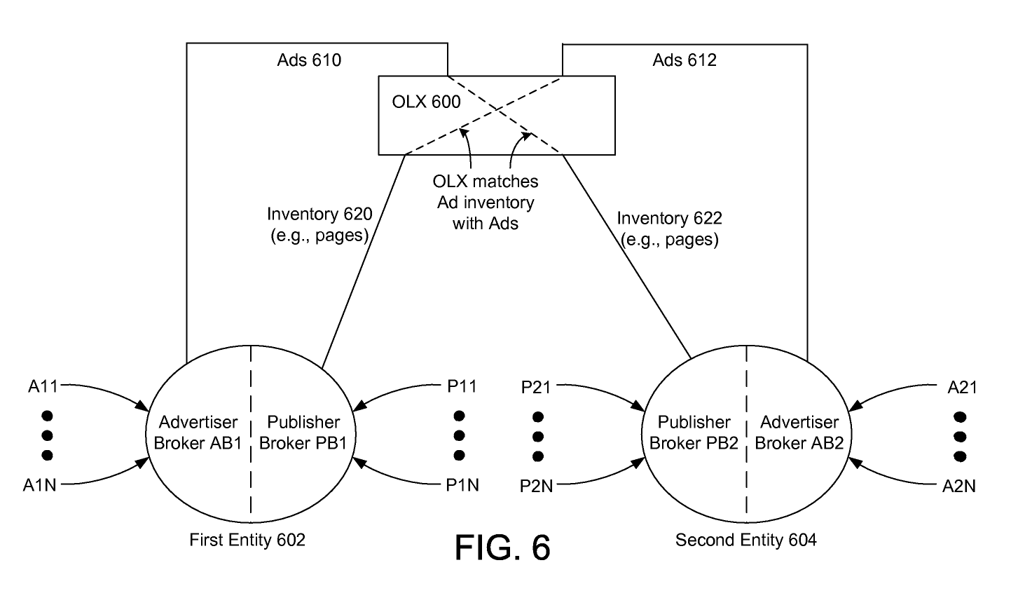

Thus, the invention can operate in a system that enables broad liquidity over distributed advertising markets, such as the above-described advertising exchange systems. FIG. 6 illustrates a conceptual block diagram of an on-line advertising exchange 600 provided in accordance with the invention. As shown, a first entity 602 and a second entity 604 are subscribers to the services of exchange 600. First entity 602 may have an advertiser broker AB1 for brokering advertisements 610 from a variety of sources A11 thru A1N and/or a publisher broker PB1 for brokering inventory 620 from a variety of publishers P11 thru P1N. A goal of ad broker AB1 is to find inventory for existing advertisements. A goal of publisher broker PB1 is to represent publishers, i.e., to help obtain revenue for their inventory (e.g., pages). Similarly, second entity 604 may have an advertiser broker AB2 for brokering advertisements 612 from a variety of sources A21 thru A2N and/or a publisher broker PB2 for brokering inventory 622 from a variety of publishers P21 thru P2N.

In accordance with embodiments of the invention, by providing ads 610 and 612 to OLX 600 according to a first communications layer, and by providing inventory 620 and 622 to OLX 600 according to an independent communications layer, OLX 600 can efficiently match advertisements to available inventory with greater simultaneous knowledge of multiple advertising networks. Since any advertising network can plug into the federated exchange 600, the invention operates to federate disparate advertising networks according to a common architecture that can benefit all participants as a result of the greater scale.

For instance, first entity 602 might be Microsoft's MSN Web site, and second entity 604 might be Yahoo's portal Web site. For simplicity, FIG. 6 illustrates only two entities, but advantageously, the invention can also be scaled to accommodate any number of advertising networks, e.g., eBay, Amazon, Google, etc.

Having thus described some exemplary advertising exchange environments in the context of the invention, various non-limiting embodiments of the value sharing for the valuable addition of information by users of an advertising exchange or advertising framework in accordance with the invention are now presented in more detail below.

### Value Sharing for Distributed Users

As mentioned, for a multi-party advertising exchange, the invention enables distributed users to provide information of potential value to the exchange, which is quantified in terms of the value added to transactions in the exchange or conferred upon its participants. In exchange, and to incent the provision of such valuable information by users, a benefit, such as a percentage of revenue or expected revenue obtained as a result of the information, is shared with those users that provide valuable information in accordance with the invention. As a result, users are incented by personal gain to generate information of positive value to the exchange and/or participants in the exchange, making the exchange marketplace more efficient and certain for its participants.

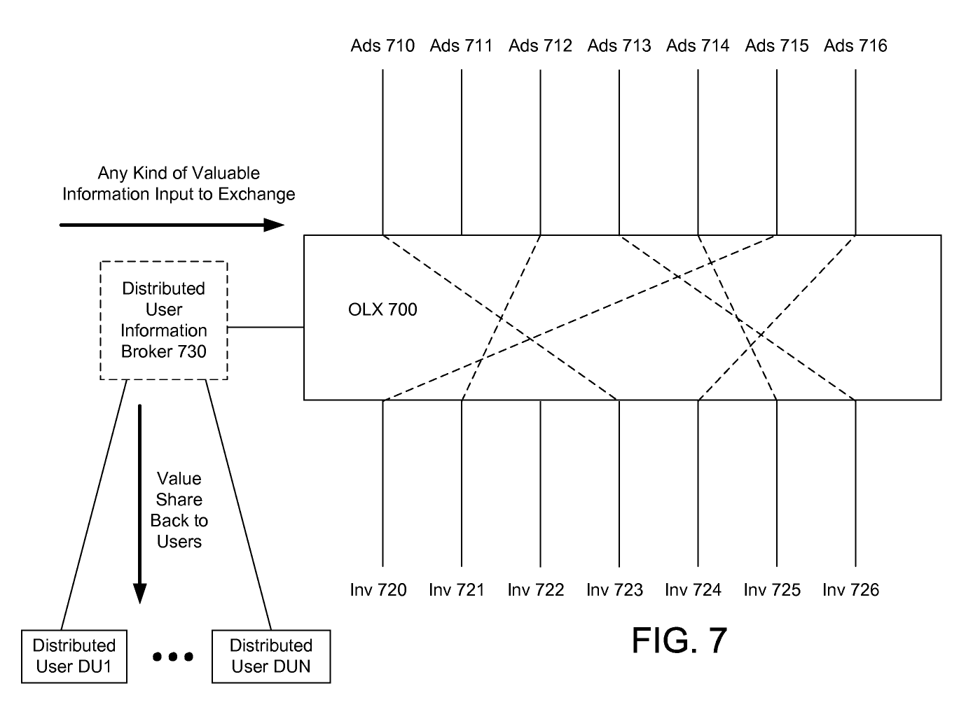

This is generally illustrated in the block diagram of FIG. 7 showing an OLX 700 that accommodates a wide range of advertising 710, 711, 712, 713, 714, 715, 716, etc. from a wide range of parties, and also accommodates a wide range of publishing inventory 720, 721, 722, 723, 724, 725, 726, etc. from a wide range of parties. OLX 700 then makes the best assessment of how to match advertising content with inventory according to a variety of policies (e.g., maximizing ad revenue, maximizing quality of advertising, maximizing conversion rate, maximizing some performance metric, etc.).

In accordance with embodiments of the invention, as shown in FIG. 7, OLX 700 includes the general ability for any of N individual users DU1 to DUN to provide information or data into the exchange transactional ecosystem that provides extra value, e.g., by making the exchange 700 more efficient, or by enriching the experience or results of the participants in the exchange who become more informed about transactions in which they are interested. In this regard, as indicated by the dashed surrounding, distributed user information broker 730 may be a user broker for purposes of brokering information of potential value to the exchange and/or its participants received from any of distributed users DU1 to DUN. In exchange for any kind of valuable information input to the exchange directly or indirectly by distributed users DU1 to DUN, value is shared back automatically to the users DU1 to DUN commensurate with a quantifiable value added to one or more transactions in the exchange.

While various non-limiting embodiments of the invention are described in the context of a single or a few such distributed users, this is for ease of conceptual presentation. It can be appreciated that the invention inherently applies to a great number of users who may provide potentially valuable information to the exchange, from whom aggregate information can be extracted, which, due to the law of strong numbers, can help to reduce uncertainty in exchange transactions. This applies to the generally growing number of people who have access to the tools provided in accordance with the invention by which users can provide valuable information to the advertising exchange and receive a corresponding benefit in return.

Accordingly, in various non-limiting embodiments, the invention provides tools, services, applications, systems, etc. by which users can generate valuable information, and provide the information to an advertising exchange in a useful format. Then, the value of the information may be quantified according to a function defined by the participant and/or exchange, and then shared back to the user as a function of the quantifiable value. Thus, distributed users who wish to gain or profit by providing information to the advertising exchange are provided with one or more “hooks” into the advertising exchange according to a broad set of scenarios whereby the users can provide information of quantifiable value to the advertising exchange, and by which such users can be compensated in relation to such value.

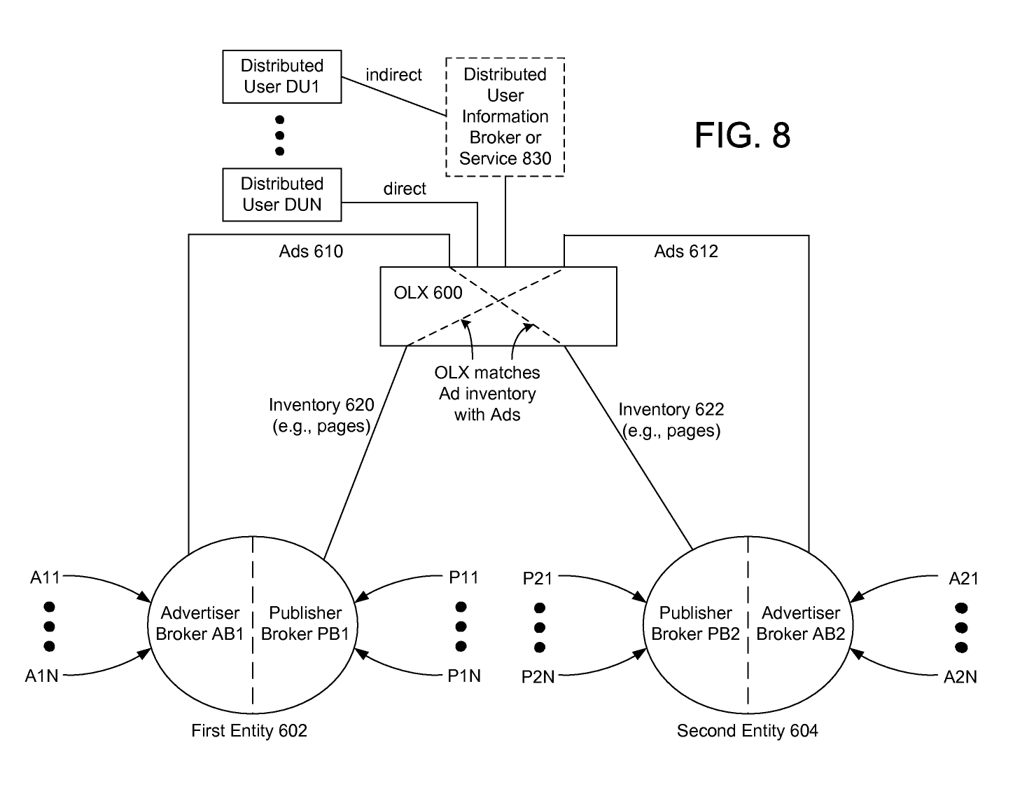

FIG. 8 is an exemplary, non-limiting system diagram generally illustrating the provision of information to a federated on-line advertising exchange, such as, but not limited to, the online advertising exchange referred to in FIG. 6. In FIG. 8, distributed users DU1 to DUN (e.g., large N), may provide information to the exchange 600 that may be valuable for transaction(s) in the exchange. Distributed users DU1 to DUN may provide the information directly to the exchange via a tool, website, form, application, service, object, etc. that collects the information, and optionally pre-processes the information for consumption by the exchange. Distributed users DU1 to DUN may also provide such information indirectly to the exchange via a distributed user information broker 830, which behaves to aggregate information from all or a subset of distributed users DU1 to DUN.

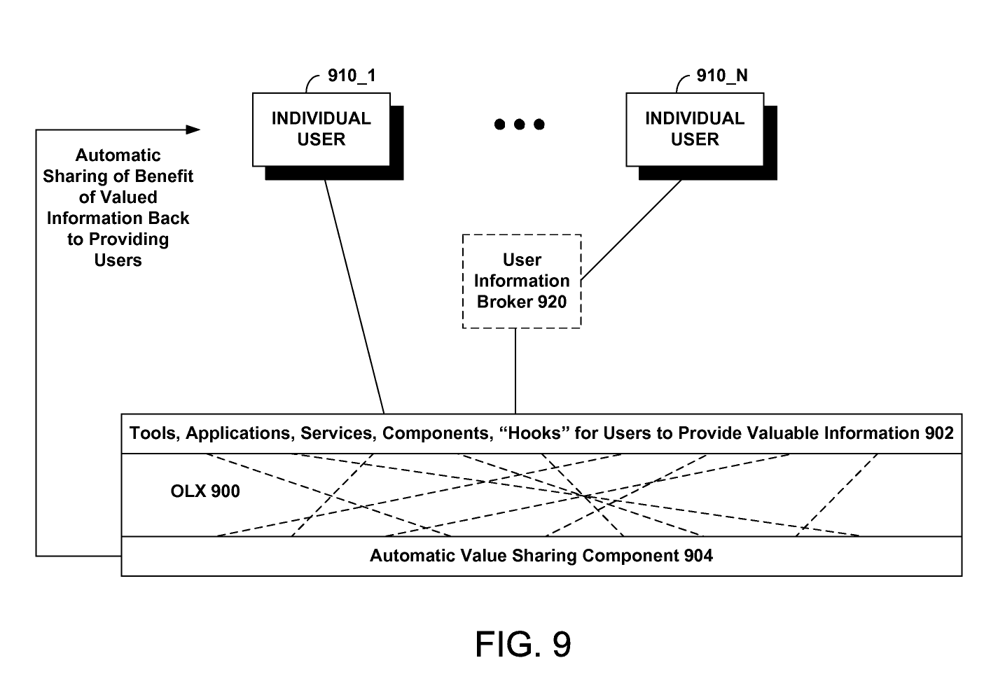

As illustrated by the exemplary block diagram of FIG. 9, the particular vehicle by which the information is conveyed by the user to the advertising exchange is also not to be limiting and may include, but is not limited to, inputting information via a Web site, a networked application, a Web service, via a telecommunications network, etc. Accordingly, the exchange itself includes, or external to the exchange, the invention provides various non-limiting embodiments of “hooks” 902 into the exchange for individual users 910_1 to 910_N, e.g., tools, applications, services, components, etc. that enable individual users 910_1 to 910_N to provide potentially valuable information to the exchange 900. As mentioned, this can be provided directly to the exchange by the individual users 910_1 to 910_N or through a user information broker 920 that aggregates and tracks user information on behalf of a set of individual users 910_1 to 910_N. Then, in accordance with the invention, a value sharing component 904 is also provided that automatically shares back benefits to the individual users 910_1 to 910_N based on the value of the information shared by those users.

Whether the information of value is input by the user to a system, application, service, etc. directly or indirectly, whether the system, application, service, etc. processes the information in some way to generate or analyze the valuable information, or whether the advertising exchange itself processes the information in some way to generate or analyze the valuable information, the value sharing proposition of the present invention may be leveraged to powerfully incent users to provide information of value to transactions in the exchange. Thus, the invention enables distributed users to provide valuable information to an online advertising network across a variety of scenarios to make for a more informed advertising ecosystem, and/or more informed participants.

The value of the information provided by the user can be determined or quantified in whole or in part by any one or more of (1) the users providing the information, (2) a system, application, service, etc. that hosts the input of information from users, (3) an advertising exchange, (4) the participant(s) of the advertising exchange or (5) or any other entity that derives value from the information provided by the user. Based on the quantified value of the information provided, the invention provides an incentive for users to take actions that add value by sharing that value back to the user in the form of a benefit or reward for the user. Optionally, such value may be shared back to the user in the form of a share of the revenue or expected revenue gained by the usage of the information provided. To encourage the input of valuable information by such distributed users, the invention thus enables automatic sharing of revenue, or some other reward, bonus, option, coupon, advantage, etc. back to such users that add value to the advertising network marketplace and participants.

The invention thus makes the advertising marketplace more efficient by incorporating extra information in the exchange, thereby reducing variance in results from advertising transactions, and/or providing participants with competitive information.

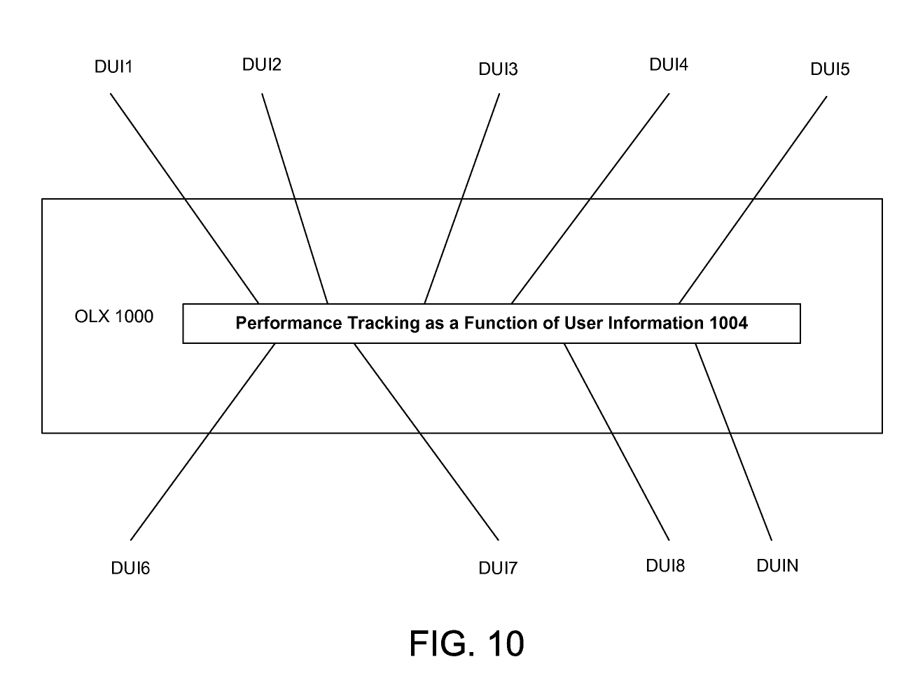

In further embodiments of the invention, performance tracking, such as conversion tracking or clickthrough rate tracking, is enabled for the exchange of the invention to provide a more solid understanding of performance value of information for advertising transactions because information is provided across advertising networks and across a great number of different users. Performance tracking enables a more holistic view of performance for different advertising products as a function of any information added by one or more distributed users in accordance with the invention. As shown by the online advertising exchange (OLX) 1000 of FIG. 10, at different levels of granularity, the invention includes the ability to track the performance of distributed user information DUI1, DUI2, DUI3, DUI4, DUI5, DUI6, DUI7, DUI8, . . . , DUIN provided to the exchange by different users.

For instance, by collecting performance information for transactions that use information provided by the distributed users via a tracking component, over time, a dynamic view is enabled over the performance of user information across the exchange. Some user's information will tend to perform better than other user's information and the value of the user's information can be made proportional to a user rating associated with the user, so that high rating users are paid more for their good reputation for high value information as part of the share back process of the invention.

For example, it is known that by increasing one's conversion rate for advertising, a marketer can lower the cost per acquisition without changing the cost paid for traffic. Even a small increase in conversion rate can have a dramatic profit impact, and so it is desirable to find publishing space with a high expected conversion rate. Or alternatively, one may actually instead desire a low expected conversion rate to maximize a different advertising goal. In this respect, with performance tracking, such as conversion tracking, provided in the distributed framework for online advertising in accordance with the invention, pricing for revenue sharing can be made more accurate because performance of information provided by individual users can be measured across numerous users, helping to average out individual transactional biases within any specific advertising network and across different users.

As a result, the efficacy of a user's information can be taken into account where there is user history, making it difficult to free ride the bona fide efforts of others to provide real value to the system. In other words, as the performance of a user's information becomes weak, the value of that user's information can be discounted in correspondence with how well the user performs. Similarly, as the user's information performs well over time, the value of that user's information may be augmented. Initially, when performance about a user is relatively unknown in terms of the information that user provides, the value of the information can be discounted appropriately to account for the risk inherent in using unknown information.

For instance, it is known that by increasing one's conversion rate for advertising, a marketer can lower the cost per acquisition without changing the cost paid for traffic. Even a small increase in conversion rate can have a dramatic impact on profit, and so it is desirable to find information that leads to publishing space with a high expected conversion rate. Thus, as one non-limiting example of performance tracking provided in the distributed framework for online advertising in accordance with the invention, pricing can be made more accurate because conversion information, or other performance information such as clickthrough rate, is available across parties. Where a correlation exists between the performance of information provided by a user and an advertising cost model used by a party, the party can quantify the information.

In one embodiment, a modifier is specified as a discount rate. For example, if a user is known to have a bad conversion rate for hosted advertisements that are based on the user information provided by that user, the share back to that user can be discounted in a way that is proportional to the modifier. As the conversion rate becomes better and better for the user's information, the modifier improves for the user, i.e., the exchange dynamically prices that publisher's space at a higher premium to recognize the improvement in conversion rate. Similarly, other performance metrics for user information can be used to dynamically lower the price for user information as well.

Initially, not a lot will be known about the performance or quality of information from an unknown user. In this respect, in various non-limiting embodiments of the invention, the exchange in effect penalizes the lack of information available about performance until more information is provided or becomes available. In this respect, the exchange of the invention can operate as an independent referral or validating source for quality advertising spaces by pricing inventory with high performance, e.g., high conversion rates, at a standard rate (e.g., 20%) higher than inventory with no known conversion history. Clickthrough rate, for instance, has been used historically as a measure of performance. Where publishers benefit from information provided by users by improving clickthrough rate, those users can be rated higher for similar reasons. Other metrics may be assumed as well.

Thus, in accordance with the invention, any measurement of performance as well as any measure of the quality level for advertisements or publishing inventory as a function of user information can be taken into account by having the exchange of the invention apply a discount rate that accounts for bad or lower quality information by reducing or eliminating the revenue realized by those users as part of the share back process of the invention.

Chumming, i.e., the strategy of establishing a trail of scents and edible bits that leads one's quarry to one's boat, can effectively be applied for advertising spaces where it is difficult to target potential customers. And the system of the invention is prone to users providing bogus information in order to attempt to reap a profit. In this respect, much like the fish in the sea, for such advertising products, it is unknown where the fish are at any given moment, but setting up a wide swath of entry points across a variety of advertising spaces acts to catch at least some fish from wherever they are. In this regard, the invention provides an infrastructure for users to inform participants in the exchange of where the fish will be biting. If the users are correct, the value of their information rises over time.

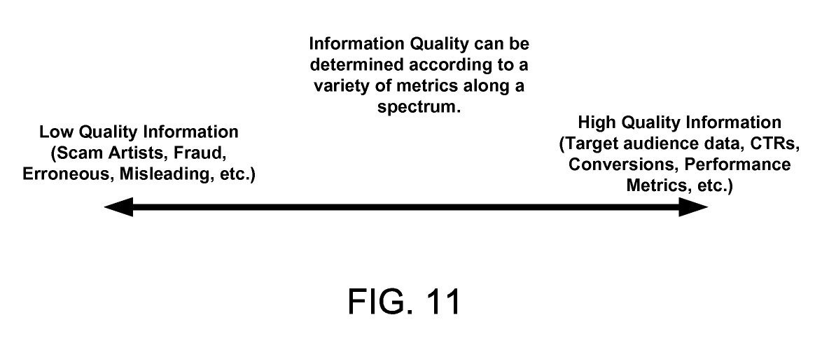

This is conceptually illustrated in FIG. 11 showing, at one side of a spectrum, low quality information (e.g., fraud, erroneous or misleading information, etc.) from low quality distributed users (e.g., scam artists, users engaging in tomfoolery, etc.) and, at the other side of the spectrum, high quality information (e.g., target audience data, performance metrics, conversions, clickthroughs, etc.) assuming the information is reliable and of interest to exchange entities.

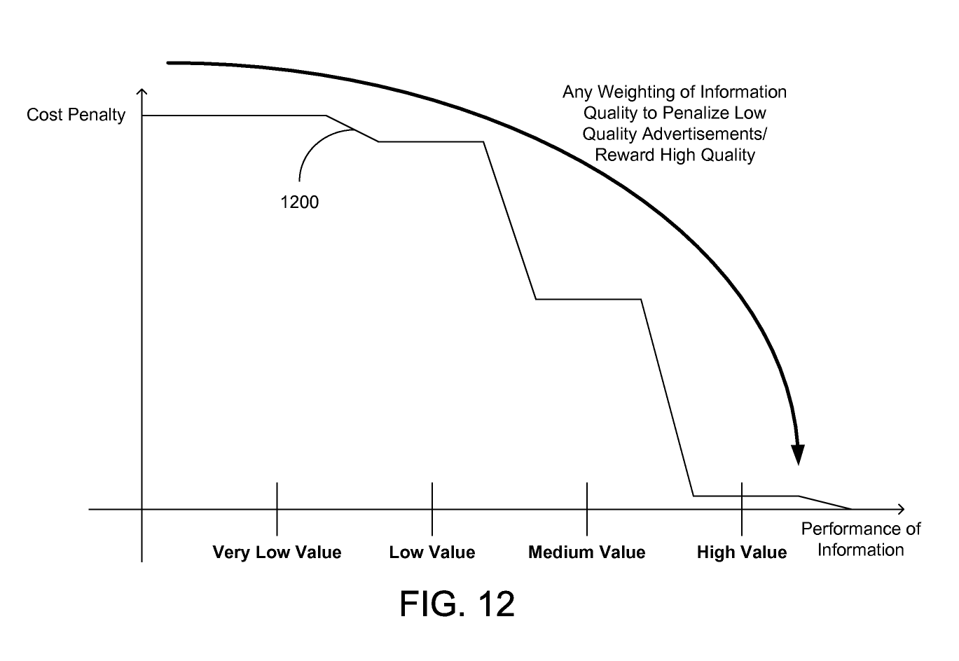

In one non-limiting implementation, as shown by non-linear curve 1200 of FIG. 12, a non-linear weighting process may optionally be adopted to weight the information provided by users as more important when matching advertisements to publishers by the exchange of the invention when the information has more value. Applying a non-linear curve based on quality serves as a corrective market force, which penalizes users that generate misinformation, or conversely, reward users that historically provide high quality information. In this regard, any non-linear weighting scheme can be applied based on a proxy for performance of information provided by users in accordance with the exchange of the invention.

In other embodiments of the invention, the exchange of the invention takes past forecasting information as input from distributed users as long as it tends to reduce the variance of expected performance for advertising transactions within the exchange. Forecasting information includes any reliable metric for predicting a future price, and includes, but is not limited to, metrics for monitoring inventory supply and demand curves, and the value sharing event that automatically occurs in accordance with the invention can be predicated on the forecasting information being correctly predictive in the future.

As a result, the invention creates a more certain marketplace with decreased variance for expected results for transactions. Since the information provided by the user likely is not useful to all participants in the exchange, the invention may also allow distributed users to submit competitive information to one or more participants of the advertising exchange, where the participants who benefit from the information provided by the user in turn compensate the associated user.

While the amount and relevance of information provided by a single user may be of small value to the overall advertising exchange ecosystem with all of its participants, in aggregate, an enormous amount of information can be harvested based on input from a lot of users. Optionally, one implementation of the invention includes a distributed information broker component that operates to aggregate user data from a plurality of users to provide a holistic view of contributions by all or a targeted subset of distributed users. In such optional embodiment, the distributed information broker component can maintain track of user contributions on behalf of the system, i.e., record which information came from which users in order to compensate those users commensurate with the value of their input.

Overall, increasing the amount of knowledge in the ecosystem of the advertising exchange makes for more efficient transactions since knowledge can reduce uncertainty and risk in decision making by the parties, both in terms of gaining a competitive advantage in a transaction by knowing something others do not know, or by having more consistent expectations for transaction results. In this respect, the invention increases the ability of participants to an advertising exchange to make more rational decisions about advertising transactions vis-a-vis the valuable information provided by distributed users. As a result, the advertising marketplace is better defined as between individual participants, making for more efficient and rational transactions among those participants, thereby yielding a more efficient marketplace for all.

In various embodiments, an advertising system to facilitate trading of advertising, such as a federated advertising exchange that provides a federated advertising layer for disparate advertising networks, includes (A) a publisher broker to represent publishers that determines an ask for an advertisement space on the publishers' inventory, such as a webpage, (B) an advertiser broker to represent advertisers that manages the advertisers' bids for the advertisement space to display the advertisers' advertisements and (C) an exchange to facilitate a transaction for the advertisement space between the publisher broker and the advertiser broker. As mentioned, the invention provides for distributed user input of information to the advertising system, from which value is derived in the exchange, and based on which value a benefit is shared back to the distributed users.

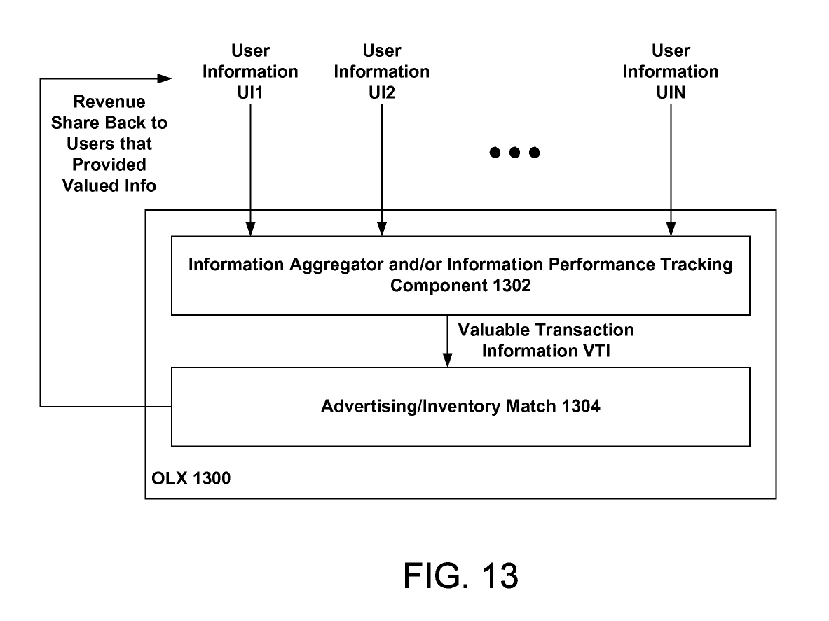

The high level block diagram of FIG. 13 illustrates an exemplary, non-limiting embodiment for the reception of potentially valuable user information by an exchange to enrich the transaction environment in accordance with the invention. User information UI1, UI2, . . . , UIN is received by the exchange 1300 by an information aggregator and/or information performance tracking component 1302, providing a layer of information from which participants can select information of relevance to their transactions in the exchange, e.g., information about a particular target demographic, information about the performance history for a user's information, information about the performance characteristics of publishing or advertising inventory, etc. Information of interest to a participant in the exchange becomes valuable transaction information VTI for that participant, meaning simply that the information has some value to that participant. When the participant then utilizes that information as part of advertising/inventory match process 1304, some quantifiable measure of the value of that information is used to share back some revenue to the users as shown by the arrow on the left. As an ongoing process, users acquire quality ratings that enable them to receive a greater share of revenue back as their information proves valuable in exchange transactions.

In one non-limiting embodiment, an exchange tax revenue source funded by the participants in the network is used to compensate any distributed users that quantifiably reduce variance in transactions in the exchange. Since more certainty in transactions in the advertising exchange benefits all parties to the exchange, it is fair to assess a tax, e.g., 1%, against all participants, e.g., by applying the tax to each transaction conducted in the exchange.

On the other hand, in other non-limiting embodiments of the invention separate from or provided in combination with the exchange tax above, individual participants of an advertising exchange bear the burden of compensating the individual users. This is appropriate where only an individual participant in the exchange, or a subset of individual participants, benefit from the information. For instance, information about the correlation keyword “swimsuit” to a particular demographic might not be particularly valued by a snowboard manufacturing company, but might be particularly coveted by designers or retailers of swimwear. Thus, it stands to reason commensurate with the value that a recipient derives from the information that, in this example, the designers or retailers of swimwear would compensate the users that provided such information, whereas the snowboard company would not be interested.

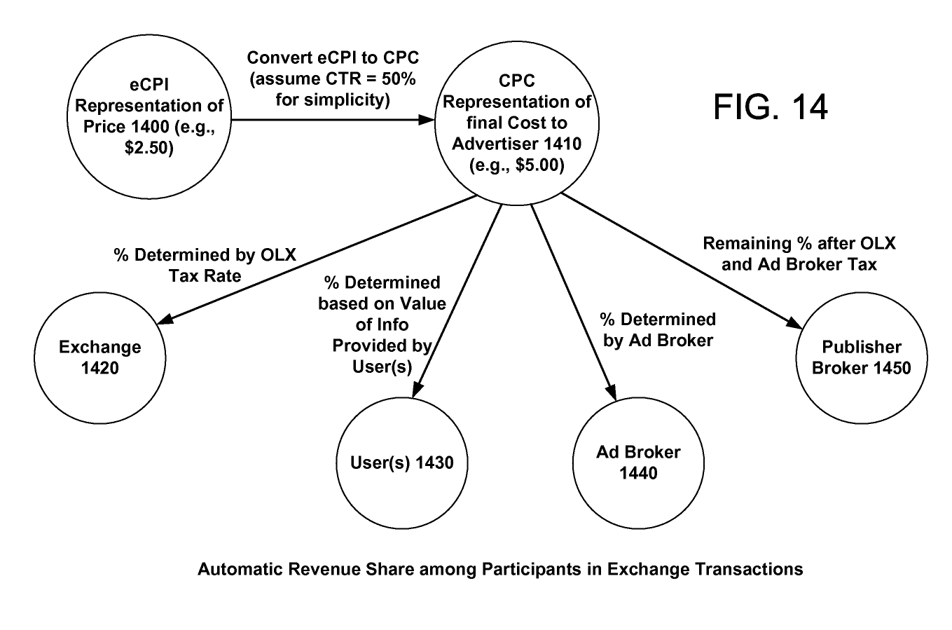

Exemplary division of revenue according to an embodiment of value sharing of the invention is illustrated in exemplary fashion in FIG. 14. As part of a hypothetical transaction, an eCPI price 1400 is converted into a CPC representation 1410 of the final cost to the Advertiser as shown. For instance, assuming a 50% CTR, a eCPI price of $2.50 is converted to a CPC cost of $5.00, of which a percentage can go to the exchange 1420 as an exchange tax, a portion may go to the user(s) 1430 that provided valuable information and/or to user information brokers (not shown), a portion of which may go to the ad broker 1440 with the remainder to the publisher broker 1450.

As mentioned, the invention can be applied to a limitless number of scenarios where a user may provide information of potential value to an advertising exchange, assuming the users are willing to spend their time in that manner. Thus, sharing of revenue is enabled in a broader and more flexible manner in order to reward any third party participants in the advertising marketplace, i.e., to revenue share to encourage the adding of value to an advertising network. The exchange operates to reward third parties (transaction intermediaries and independent users) beyond the seller and purchaser who facilitate a content match between the parties in a way that either the seller or purchaser wishes to provide incentives for the behavior through revenue sharing. When users add value to a page in some fashion, by drafting a great review of a product with which others agree, adding text to the page that improves search matching with the content on the page, etc., the behavior is thus validated, where appropriate, by distributing the revenue back to those that add value. Other non-limiting examples of ways that users can add value to advertisers and publishers for which revenue sharing can be enabled include digging, trend spotting and obtaining expert status.

In other non-limiting embodiments of the invention, the invention enables the sharing of revenue in a broader and more flexible manner, in order to reward any third party participants in the advertising marketplace, such as other users, Paypal, Livepay, etc., i.e., to revenue share to encourage the adding of value to an advertising network. Thus, where a Livepay service handles a transaction on behalf of the exchange of the invention to purchase advertising inventory, the ease of the transaction made possible by the Livepay service can be rewarded as defined by the participants in the transaction. Another example is when an ad viewer may refer certain ad content to another person the ad viewer knows may be interested in the ad content. In such instance, the ad viewer, while they have not purchased anything themselves, i.e., have not converted by themselves, they have provided a conversion if the person to whom the ad content was referred purchases the ad content. In such case, the exchange can take into account referral information to share revenue to the ad viewer in accordance with the reward policy of the advertiser for such conduct.

As another example, some users take the time to apply more descriptive tags to Web sites, which help better lead customers to certain targets. For instance, a user might tag a Blog that reviews old muscle cars with the tags “autos,” “review,” “Ford” and “Mustang.” If it turns out, the advertising on the Blog has better monetization with the tags relative to the monetization of the Blog without the tags, then the exchange of the invention enables revenue sharing with the user that tagged the Blog to make the Blog a more effective publisher of advertising.

In yet another example, mapping information between imagery and keywords that describe is collected as part of a survey, or a game. For instance, a game can be played where disparate online users at different locations both observe imagery, the same imagery, but the users can only collaborate by text. In this game, a word will be mapped to the imagery if and only if two users type the same text. With more users, the value of the information becomes even stronger where correlations exist. In a world where the imagery is products, and the words typed are keywords, it is apparent that this can be a powerful tool for gaining insight into marketing and advertising information. For instance, retailers could use such information to help label products from a keyword search standpoint. For instance, today, without this kind of information, one is left to guess what user keywords one might type for certain unfamiliar kinds of products. In return for spending the user's time generating the mapping information (and having fun playing the game), the user can be rewarded by the share back mechanism of the present invention.

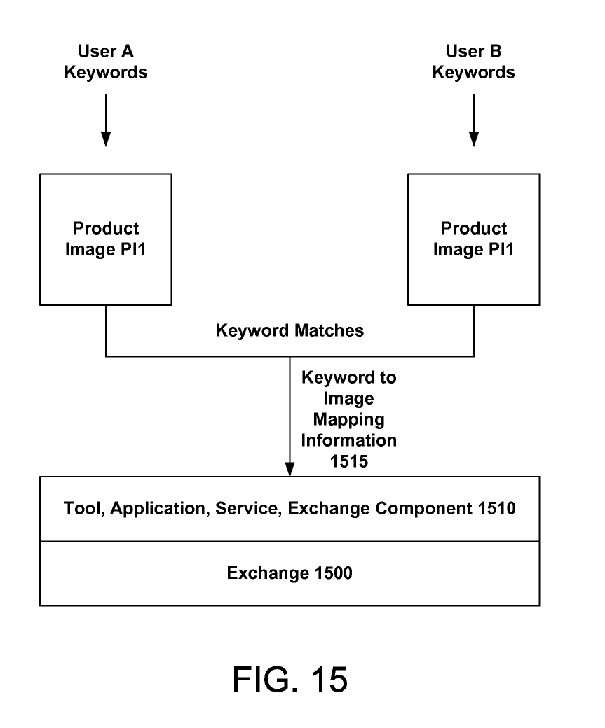

An exemplary embodiment of such a game that would provide valuable keyword mapping information is illustrated in FIG. 15. Both users A and B provide keywords to different devices based on viewing the same image PI1. When the keywords they enter match, keyword image mapping information 1515 is created that has value to an exchange 1500. This information can be collected by a tool, application, service, exchange component, component external to the exchange, etc. 1510. Component 1510 can perform some additional processing of the information prior making the information available, batch or aggregate the information, parse the information into categories, etc., and/or keep track of benefit share back for users in accordance with the invention.

In a broader sense, the invention thus operates to reward third parties (transaction intermediaries and independent users) beyond the seller and purchaser who facilitate a content match between the parties in a way that either the seller or purchaser wishes to provide incentives for the behavior through revenue sharing. When users add value to a page in some fashion, by drafting a great review of a product with which others agree, adding text to the page that improves search matching with the content on the page, etc., the behavior is thus validated, where appropriate, by distributing the revenue back to those that add value.

Other non-limiting examples of ways that users can add value to advertisers and publishers for which revenue sharing can be enabled include digging, trend spotting and obtaining expert status. With digging, a user browsing a publisher's site can state “I like this story” which causes the story to move up in popularity, which can create a snowballing effect that makes the site popular, which in turn generates more revenue for the story. Such self-organizing editorial feature for sites generates a lot of additional traffic which is monetizable, and can be shared back to any early users contributing to snowball effect.

In a more general sense, digging a page can be treated as a financial instrument handled by the exchange much the way any other financial instrument is handled. In essence, spending the time to dig by the user is equivalent to buying long on whether the page will be popular. If it is popular, the digging user receives a share back of the resulting monetization. Digging and like behavior, which can potentially add value to advertising product, thus creates a new class of user—the trend spotter. Before the snowball for a story, content, etc. begins, i.e., before the popularity of a space is known, the trend spotter attempts to predict the popularity of the page and to potentially contribute to the popularity of the page through editorial remarks. When a trend is spotted correctly, revenue associated with the monetization of the trend can be shared back to the trend spotter.

In addition, trust can be propagated for trend spotters that continue to perform well over time, making them experts. In essence, the first time someone spots a trend, he or she may have been lucky—the second time too, but at some point, e.g., the tenth trend spotted in a row, the successful performance of trend spotters becomes demonstrative. The better the success rate of the trend spotters, the more valuable their input to the exchange becomes to advertisers and publishers, and as a result, over time, the revenue that is shared back to the trend spotter increases in correspondence with well the trend spotter does (or decreases in correspondence with how poorly the trend spotter does).

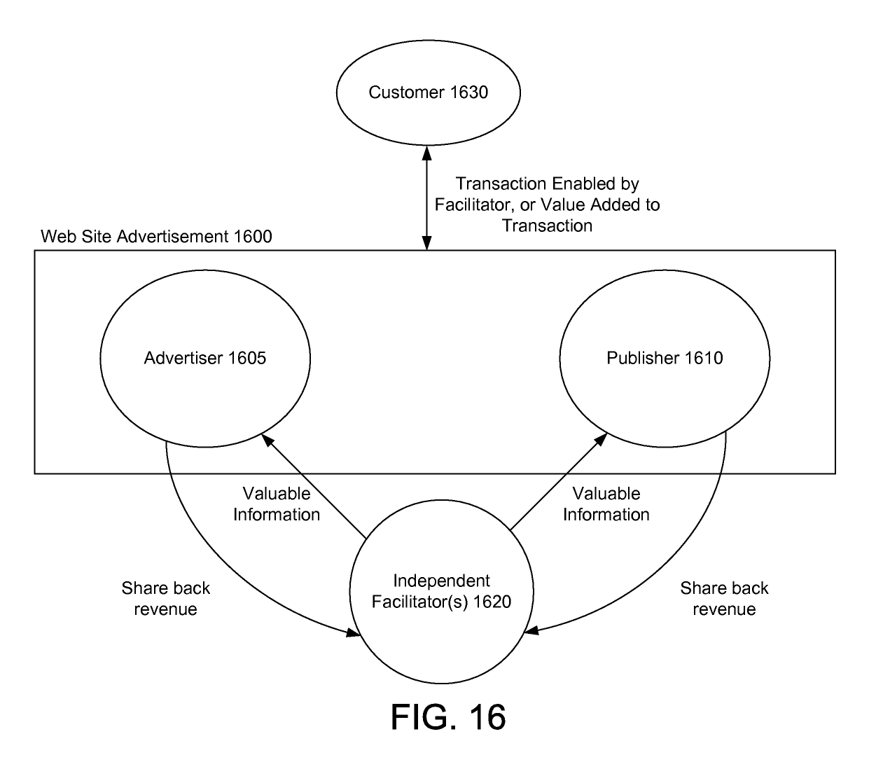

Diagrammatically, this is illustrated in exemplary non-limiting detail in FIG. 16, wherein an advertiser 1606 and a publisher 1610 together have a contract for advertising based on conversions of Web page advertisement 1600 from advertiser 1605 displayed on the web page of publisher 1610. Where facilitator 1620 operates to facilitate a conversion on Web page advertisement by customer 1630, e.g., by adding tags that make search more relevant thereby bringing higher quality customers from the perspective of the advertiser, or by forwarding the Web page advertisement to a friend known to be a potential customer, it may be in the interest of advertiser 1605 and/or publisher 1610 to share revenue associated with the increased conversions. The exchange of the invention can be configured to recognize the value of such facilitators and revenue share back to the facilitators in proportion to their value add.

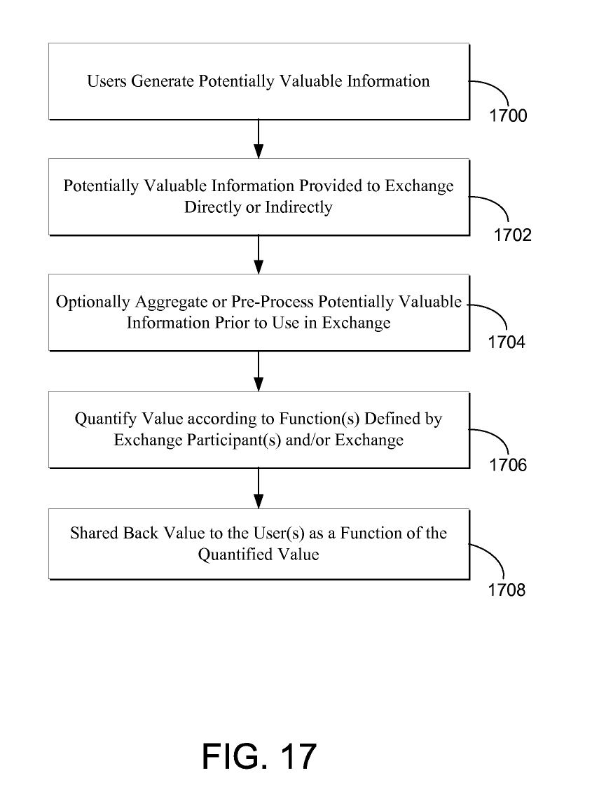

FIG. 17 is a flow diagram illustrating an exemplary process for value sharing back to users that contribute valuable information to a federated online advertising exchange in accordance with the invention. At 1700, users generate potentially valuable information. At 1702, users provide the potentially valuable information to any of a set of tools, services, exchange component, applications, systems, etc. that receives the information on behalf of the exchange. At 1704, the information optionally may be aggregated or pre-processed prior to use within the exchange, i.e., prior to exposing the information to participants in the exchange. Then, at 1706, the value of the information may be quantified according to a function defined by the participant and/or exchange, and then shared back to the user as a function of the quantifiable value at 1708. This may be made dependent on the performance of the information, or a performance metric associated with the user's past information. Thus, distributed users who wish to gain or profit by providing information to the advertising exchange are provided with one or more “hooks” into the advertising exchange according to a broad set of scenarios whereby the users can provide information of quantifiable value to the advertising exchange, and by which such users can be compensated in relation to such value.

In various non-limiting embodiments, the information may be provided in the form of marketing, demographic, or other survey information that enriches the knowledge by advertisers of effective target audiences. For some non-limiting examples, the information may be provided as part of an on-line game, one or more applications, a service such as a Web service, a form, a pluggable component into existing components or Web sites.

The invention may also be implemented in a peer-to-peer architecture, wherein processing performed by the exchange of the invention is shared across multiple participating machines. In such a non-limiting embodiment, each machine participating in the exchange network enabled by the invention can share some of the processing associated with normalization processes performed by the various embodiments of the on-line exchange of the invention.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

There are multiple ways of implementing the present invention, e.g., an appropriate API, tool kit, driver code, operating system, control, standalone or downloadable software object, etc. which enables applications and services to use the advertising techniques of the invention. The invention contemplates the use of the invention from the standpoint of an API (or other software object), as well as from a software or hardware object that operates according to the advertising techniques in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to advertise. While exemplary programming languages, names and/or examples are chosen herein as representative of various choices, these languages, names and examples are not intended to be limiting. One of ordinary skill in the art will also appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the advertising techniques of the present invention, e.g., through the use of a software object, data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to one or more of the figures. While for purposes of simplicity of explanation, in some cases, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide the disclosed embodiments for advertising methods. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for facilitating transactions for advertisement space in an advertising exchange including a publisher broker to represent at least one publisher and an advertiser broker to represent at least one advertiser, wherein the advertising exchange federates at least two disparate advertising networks, comprising:
receiving information from a plurality of distributed users including associating the information with the user originating the information;
for each user of the plurality of distributed users, quantifying the value of any information received from the user according to a function that represents a value of the information to one or more transactions conducted in the exchange; and
automatically generating a benefit for each user as a function of the quantifiable value of the information provided by each user.

2. The method of claim 1, further including:
aggregating the information from the plurality of users prior to the quantifying step.

3. The method of claim 2, wherein the quantifying includes determining the value of each user's information in proportion to the value of each user's information relative to the value of the aggregated information.

4. The method of claim 2, wherein the generating includes generating a benefit for each user as a function of the quantifiable value of the aggregated information.

5. The method of claim 1, further comprising:
preserving privacy of the plurality of distributed users by obscuring the identity of the user providing the information while maintaining the association from the information to the user that provided the information for said generating step.

6. The method of claim 1, wherein said generating includes sharing revenue to each user as a function of the quantifiable value of the information provided by each user.

7. The method of claim 1, wherein said receiving includes receiving the information for a subset of the plurality of distributed users indirectly via a user information broker.

8. The method of claim 1, further including:
tracking at least one performance metric for information received by each user and wherein the quantifying includes quantifying the value of the information from each user based on the at least one performance metric for the information received by each user.

9. The method of claim 1, wherein the receiving includes receiving information from an end user of the plurality of distributed users via a user interface provided for interfacing with the advertising exchange.

10. The method of claim 8, further including:
determining a quality rating for each user based on the at least one performance metric for information received by each user.

11. A method for facilitating transactions for advertisement space in an advertising exchange that federates participants including publishers and advertisers between at least two disparate advertising networks, comprising:
receiving, from a user of a plurality of distributed users, information by the advertising exchange according to at least one input process, and
if the information has value to at least one participant in the advertising exchange, automatically providing a benefit by the user commensurate with the value of the information to one or more participants according to one or more transactions conducted in the advertising exchange based on the information.

12. The method of claim 11, wherein the receiving includes automatically receiving a share of the revenue or expected revenue associated with the one or more transactions conducted in the advertising exchange based on the information.

13. The method of claim 11, wherein the inputting includes inputting performance information for advertising inventory or publishing inventory.

14. The method of claim 11, wherein the inputting includes inputting conversion rate information or clickthrough rate information concerning advertising inventory or publishing inventory.

15. The method of claim 11, wherein the inputting includes inputting mapping information between images and words that describe the images.

16. The method of claim 11, wherein the inputting includes inputting mapping information between objects of a web site and tags that describe the objects.

17. The method of claim 11, wherein the inputting includes inputting information about a target audience for advertising inventory or publishing inventory.

18. The method of claim 11, wherein the inputting includes inputting information that reduces the variance of outcome for expected results for one or more participants to at least one transaction in the exchange.

19. The method of claim 11, wherein the inputting includes inputting information about trust level for one or more participants to at least one transaction in the exchange as a measure for how much the one or more participants can be trusted based on past history.

20. A system to facilitate trading of advertising, comprising:
an exchange to facilitate a transaction between a first entity and a second entity for advertisement space across disparate advertising networks; and
a facilitator that facilitates the transaction with information that increases the probability of completing at least one transaction in the exchange,
wherein the exchange automatically shares revenue to the facilitator based on the value of the information to the first entity or second entity.
